(19) United States
(12) Patent Application Publication
(10) Pub. No.: US 2025/0356681 A1
(43) Pub. Date: Nov. 20, 2025

(54) MONOCULAR SKELETAL POSE INFERENCING

(71) Applicant: LIDAR Engineering, LLC, Raleigh, NC (US)

(72) Inventors: Ulysses Grisette, Bermuda Run, NC (US); Matthew Lane Werner, Pentwater, MI (US)

(21) Appl. No.: 19/212,249

(22) Filed: May 19, 2025

Related U.S. Application Data
(60) Provisional application No. 63/648,911, filed on May 17, 2024.
(60) Provisional application No. 63/750,408, filed on Jan. 28, 2025.

(51) Int. Cl. G06V 40/10; G06V 10/32; G06V 10/44; G06V 10/764; G06V 10/77; G06V 10/94; G06V 20/52; H04N 5/76

(52) U.S. Cl. CPC G06V 40/10; G06V 10/32; G06V 10/44; G06V 10/764; G06V 10/7715; G06V 10/95; G06V 20/52; H04N 5/76

(57) ABSTRACT

Systems disclosed herein are directed to a system including at least one processing unit, and at least one memory coupled to the at least one processing unit and storing instructions for execution by the at least one processing unit, wherein the instructions, when executed by the at least one processing unit, cause the system to perform actions including identifying, by a processing circuitry, a subject in a room on a camera feed received from a monocular camera via a network with an objection detection model; mapping, by the processing circuitry, key points of the subject in the camera feed with a pose estimation model; classifying, by the processing circuitry, a pose of the subject based on the key.

### CROSS REFERENCE TO RELATED APPLICATIONS

This application claims the benefit of and priority to U.S. Provisional Application No. 63/648,911 entitled “MONOCULAR SKELETAL POSE INFERENCING” and filed May 17, 2024, and U.S. Provisional Application No. 63/750,408, entitled “MONOCULAR SKELETAL POSE INFERENCING” and filed Jan. 28, 2025, the entirety of each of which is hereby incorporated by reference herein for all purposes.

### TECHNOLOGICAL FIELD

The present disclosure is related to pose detection with a camera.

### BACKGROUND

With the growing aging community and overall shortage of healthcare workforce, the need for automating the process for detection of falls is a growing need. Previous solutions for detection of falls include wearable devices, pressure mats and remote monitoring services. Camera based solutions use expensive 3D time of flight cameras or stereo vision systems as an alternative to traditional fall detection systems to determine a subject's pose. However, there is a need for a cost-effective scalable solution for determining a subject's pose and the appropriate response to adverse events.

### BRIEF SUMMARY

The present disclosure thus includes, without limitation, the following example embodiments.

Some example implementations provide a computer-implemented method including: identifying, by a processing circuitry, a subject in a room on a camera feed received from a monocular camera via a network with an object detection model; mapping, by the processing circuitry, key points of the subject in the camera feed with a pose estimation model; classifying, by the processing circuitry, a pose of the subject based on the key points; and sending an alert over the network based on the classified pose to a client device.

Some embodiments disclosed herein are directed to a system including: at least one processing unit; and at least one memory coupled to the at least one processing unit and storing instructions for execution by the at least one processing unit, wherein the instructions, when executed by the at least one processing unit, cause the system to perform actions comprising: identifying, by a processing circuitry, a subject in a room on a camera feed received from a monocular camera via a network with an objection detection model; mapping, by the processing circuitry, key points of the subject in the camera feed with a pose estimation model; classifying, by the processing circuitry, a pose of the subject based on the key points; and sending an alert over the network based on the classified pose to a client device.

These and other features, aspects, and advantages of the disclosure will be apparent from a reading of the following detailed description together with the accompanying drawings, which are briefly described below. The disclosure includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed disclosure, in any of its various aspects and embodiments, should be viewed as intended to be combinable unless the context clearly dictates otherwise.

### BRIEF DESCRIPTION OF THE DRAWINGS

Having thus described example implementations of the disclosure in general terms, reference will now be made to the accompanying figures, which are not necessarily drawn to scale, and wherein:

FIG. 1 illustrates an example of the skeletal pose inferencing system and its data flow according to embodiments of the present disclosure;

FIG. 2 illustrates an example of the skeletal pose inferencing system according to embodiments of the present disclosure;

FIG. 3 illustrates an example of the skeletal pose inferencing system with ID Guard according to embodiments of the present disclosure;

FIG. 4 illustrates an example of the skeletal pose inferencing system with ID Guard and event assignment according to embodiments of the present disclosure;

FIG. 5 illustrates an example of the skeletal pose inferencing system with ID Guard and event assignment according to embodiments of the present disclosure;

FIG. 6 illustrates an example of the skeletal pose inferencing system with event assignment according to embodiments of the present disclosure;

FIG. 7A illustrates an example application of the skeletal pose inferencing system interface according to embodiments of the present disclosure;

FIG. 7B illustrates an example application of the skeletal pose inferencing system interface according to embodiments of the present disclosure;

FIG. 8 illustrates exemplary aspects of a computing system according to one or more embodiments described hereby;

FIG. 9 illustrates exemplary aspects of a communications architecture according to one or more embodiments described hereby;

FIG. 10A-E illustrates an example of the skeletal pose inferencing system detecting multiple subjects according to embodiments of the present disclosure; and

FIG. 11 illustrates an example of a label me function of the skeletal pose inferencing system according to embodiments of the present disclosure.

Various features, aspects, and advantages of the embodiments will become more apparent from the following detailed description, along with the accompanying figures in which like numerals represent like components throughout the figures and text. The various described features are not necessarily drawn to scale but are drawn to emphasize specific features relevant to some embodiments.

### DETAILED DESCRIPTION

Conventional solutions for fall detection include wearable devices, pressure mats, remote monitoring services, and other devices. These conventional solutions and products only determine when someone has fallen and do not address the follow up steps such as notifications, alarms, or event classification. This system describes a low cost, monocular camera with cloud-based system to infer the pose of a subject using skeletal and facial feature detection. From the pose of a subject, an event can be determined. Concerning events are automatically pushed out via a text notification or likewise to a nurse, caretaker, user, or administrator if a selected event is happening in real time.

The system determines a pose of a subject in a room using a monocular camera by identifying key points of the subject, determining a pose, and a corresponding actions in response to the determined pose. The system further obscures the identity of the subject for compliance concerns, allowing the system to be deployed across a health care facility, for example, for efficient and distributed monitoring of adverse events. In an embodiment, the system may identify a subject as fallen and start a timer and stop the timer when a second subject, such as a caregiver, enters the room and save the video clip for compliance audits and patient satisfaction. Further embodiments monitor for patient repositioning, notifying a caregiver and the subject if the subject has been still for too long in effort to prevent complication from such diseases as bed sores and pneumonia.

Through the system's application the user may define what events should trigger alarms and what areas of the room are the bed, floor, etc. to help the system determine an adverse event (e.g., laying down on a bed vs. falling down on the floor). The user may save these setting per room in a facility through the application.

The techniques described improve conventional technology by providing for the system's computing to understand physical states of the subject without needing physical sensor on the patient, and it further allows for centralized monitoring across a facility. Additionally, real time monitoring and automatic saving of identity obscured video clips prevents privacy violations and ensures compliance. Furthermore, monitoring patient immobility and adverse events improves patient outcomes and enables proactive care.

In these and other ways, components/techniques described hereby may provide many technical advantages for automated monocular skeletal pose inferencing. For example, the computer-based techniques disclosed hereby may enable skeletal poses to be automatically inferenced from 2D images without the need for depth perception techniques. In another example, processing circuitry may be utilized to automatically map key points of a subject in a camera fee and classify the pose of the subject based on the key points automatically using a pose estimation model. In some such examples, the pose estimation model may include an artificial intelligence models that are trained using labeled data and poses. Therefore, the computer-based techniques of the current disclosure improve the functioning of computers, resulting in improved capabilities and more efficient operation as compared to conventional approaches. Therefore, embodiments disclosed hereby can be practically utilized to improve the functioning of a computer and/or to improve a variety of technical fields including object detection, skeletal pose inferencing, computer-based patient monitoring, and/or artificial intelligence.

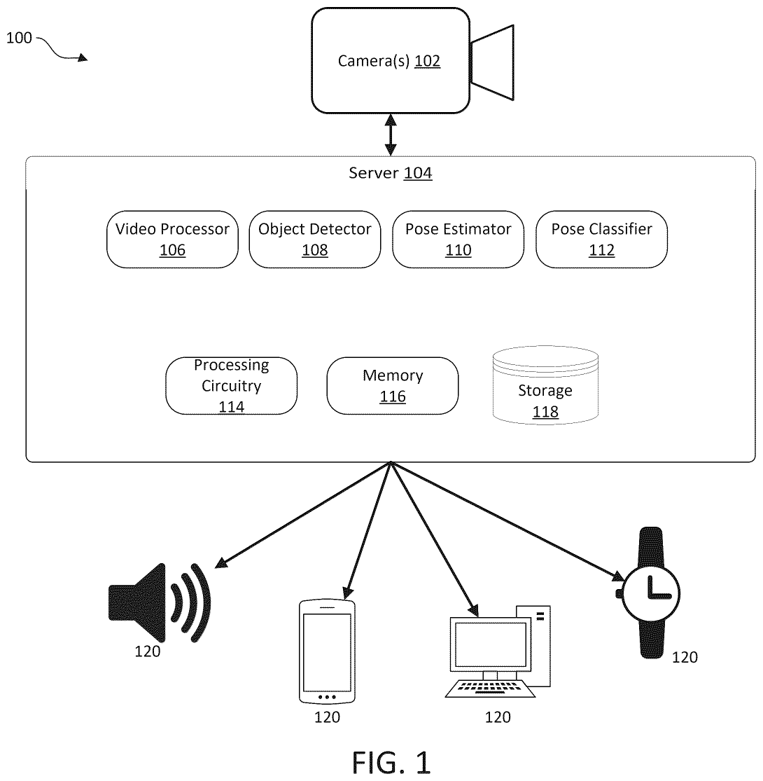

Turning to the figures, FIG. 1 shows a skeletal and facial feature detection system for monitoring adverse events. The system 100 includes a camera 102 in communication with a server 104. The server 104 may include a video processor 106, an object detector 108, a pose estimator 110, and a pose classifier 112.

The server 104 is used for processing images and video from the camera 102. The server 104 may further include processing circuitry 114, memory 116, and storage 118 (e.g., a database) for storing data processed by the server 104. A plurality of client devices 120 may be in communication with the server 104.

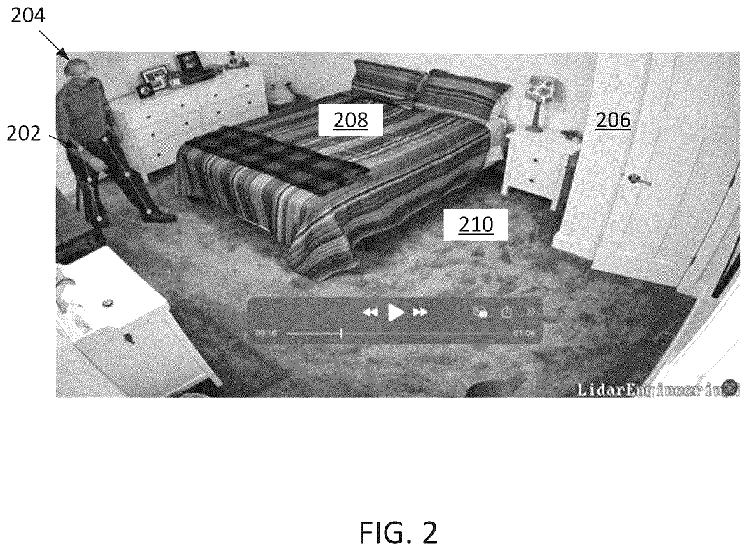

The camera 102 may be a monocular camera placed in a room to monitor a subject, as explained in relation to FIG. 2. While there is only one camera 102 shown in FIG. 1, it is understood that multiple cameras 102 may be connected to the server 104 for monitoring different rooms of a facility. The server 104 may be in communication with multiple cameras 102 of multiple facilities. The camera 102 may include only one lens (i.e., monocular) due to the cost-effectiveness of installing this type of camera throughout a facility to monitor multiple subjects with the system 100. This system 100 is described as using a monocular camera, however the system 100 may be used with more advanced cameras, such as stereoscopic camera, without changing the system architecture.

FIG. 2 is a picture of the raw video field of view (Fov) of the camera 102 of the system 100 with the pose estimator 110 having identified skeletal and facial features including identifying several key points 202 of a subject 204. The FoV may include a room 206 with a bed 208 and a floor 210. The system 100 may further be able to determine objects within the FoV to determine a subject's position. For example, the position of the subject 204 may depend on or have relation to the objects of the room. In particular, a subject horizontal on a bed may be laying down while a subject determined to be horizonal on the floor may have fallen.

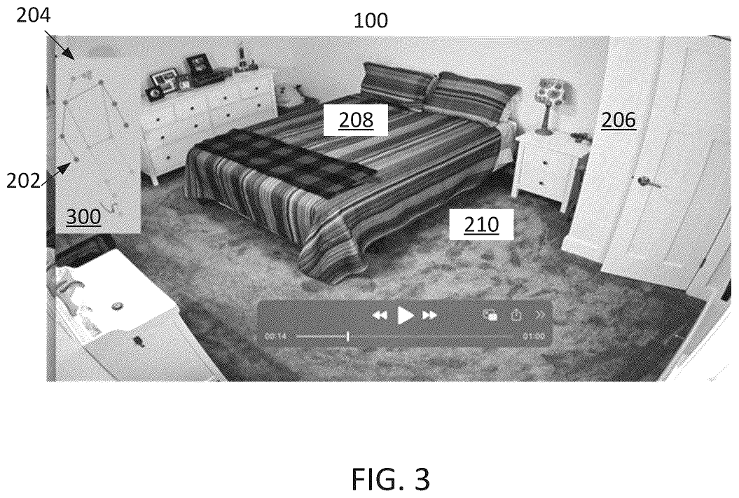

Turning back to FIG. 1, the video processor 106 may receive the video stream from the camera 102. A live video stream of the room 206 is provided over a network to the video processor 106 using, for example, Real-Time Streaming Protocol (RTSP). The video processor 106 may then perform frame extraction on the video stream to extract individual frames in real time (e.g., 15-30 frames per second). The video processor 106 may then perform preprocessing on each frame to prepare the frame for the input requirements of the object detector 108 and pose estimator 110. For example, the video processor 106 may resize and normalize each frame to match the input requirements of the object detector 108 and pose estimator 110. The video processor 106 may further perform Identity Protection as explained in relation to FIG. 3.

FIG. 3 shows the system 100 running with Identity Protection (ID Guard) for Health Insurance Portability and Accountability Act (HIPAA) compliance. FIG. 3 illustrates the system 100 operating on the same picture as FIG. 1 with ID guard as performed by the video processor 106. For example, ID Guard may remove any identifying information of a subject captured by the camera 102 by pixelating the subject before the frame or video is saved to storage 118. In some examples, only videos and images with ID Guard will be stored in the storage 118 to prevent identifying information from being accessible from the cloud. By running ID Guard on the system 100, the subject's identity is never stored in the cloud or server. ID Guard may be run by the video processor 106 on images before storage or transmission to client devices 120.

Returning to FIG. 1, the object detector 108 detects and isolates multiple subjects in the frame before running the pose estimator 110. Detecting multiple subjects in a frame may trigger certain protocols by the processing circuitry 114. For example, if a subject 204 is classified with a certain pose (e.g., fallen down), the system 100 may save the frames in a video format in the storage 118 from the time the pose is classified until the second subject enters the frame, therefore the response time is noted and saved. Further, detecting a subject in the frame allows the pose estimator 110 to apply pose estimation separately to each subject in the frame.

The pose estimator 110 uses a pose estimation model to detect skeletal facial points to identify key points 202 of each subject 102 in a frame. Key points 202 may include, for example, hips, ankles, feet, chest, chin, knees, hands, wrists, shoulders, elbows, eyes, ears, nose, and other facial and body key points. In some examples, the pose estimator 110 may include a convolutional neural networks (CNNs) to process and understand spatial features in frames and is trained to locate key points in 2D space (e.g., the frames provided by the video processor 106). The pose estimator 110 may output coordinates and a label for each key point 202. Each key point 202 also includes a confidence score between 0 and 1, representing the pose estimator 110 certainty that the key point 202 is correct.

The pose classifier 112 uses rules-based logic with a pose classification model to classify a pose of the subject 102 based on the key points 202 identified by the pose estimator 110. Utilizing key points 202, The pose classifier 112 will determine if a subject 204 is present and their spatial angles to determine their pose (e.g., sitting, standing, walking, falling, example). The spatial angles may be determined by connecting the key points 202 and calculating an angel between points relative to an axis e.g., the edges of the frame. The pose classifier 112 may include several heuristics applied to the several key points 202 and a relative position of each of the several key points 202 to determine the pose 400 of the subject 204.

Further the pose classifier 112 may use the pose classification model to classify detected motion sequences into predefined behaviors: supine position, attempting to sit, sitting, standing, walking, or fall, for example. The pose classification model may compare key point 202 positions between cached and the current frame to detect specific pose patterns. The pose classification model may be a machine learning model trained using a curated dataset of a number of samples per pose (e.g., 1000 samples per pose) from multiple angles.

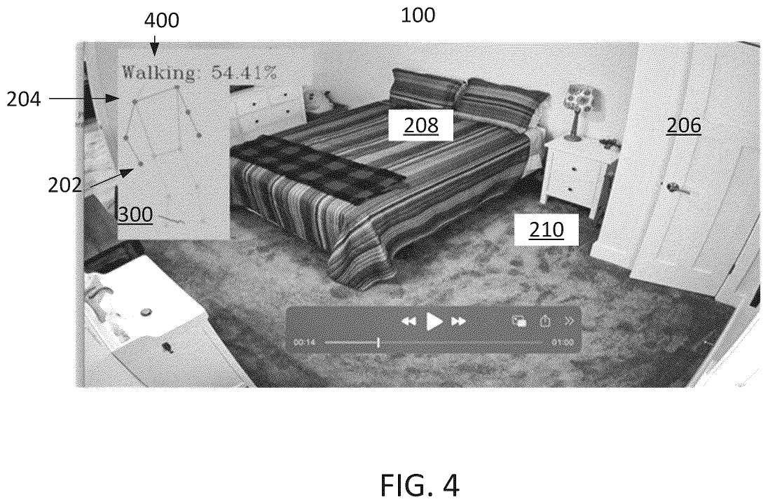

FIG. 4 illustrates the system 100 with the pose classifier 112 active. FIG. 4 has the same FoV as FIG. 2 and FIG. 3. As depicted, processing logic of the system 100 may assign a pose 400 based off the key points 202 identified by the pose estimator 110. In FIG. 4, the system 100 determines the subject's 204 pose 400 is “Walking.” The pose classifier 112 may determine a translation of each of the several key points 202 in the cache of the memory 116 to detect movement and determine a type of movement that is occurring over several frames. For example, horizontal movement of the key points 202 with respect to the floor, may indicate that the motion is walking. The pose 400 estimation may include: standing; walking; sitting; falling down; and lying down.

Determining the pose 400 by the pose classifier 112 may also include a confidence level expressed as a percentage using the pose estimator 110 confidence score for each key point 202 in a frame. The confidence score for each key point may be averaged to derive a confidence level as a percentage. For example, in FIG. 4 the confidence level is 54.41%. The confidence level may further be averaged across the cached frames or represent the confidence level for that frame.

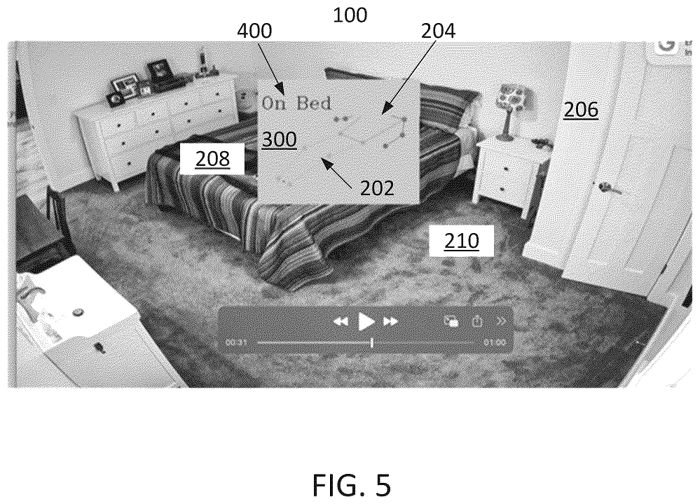

FIG. 5 illustrates the system identifying a subject 204 is on the bed 208 laying down. The pose 400 classification is “On Bed.” The system's pose classifier 112 can determine the subject 204 is the bed 208 versus the floor 210 even though the skeletal angles are flat, because the user previous identified a portion of the FoV as the bed. The system 100 may include a method of identifying certain items in the room such as a bed to distinguishing falling down versus on bed.

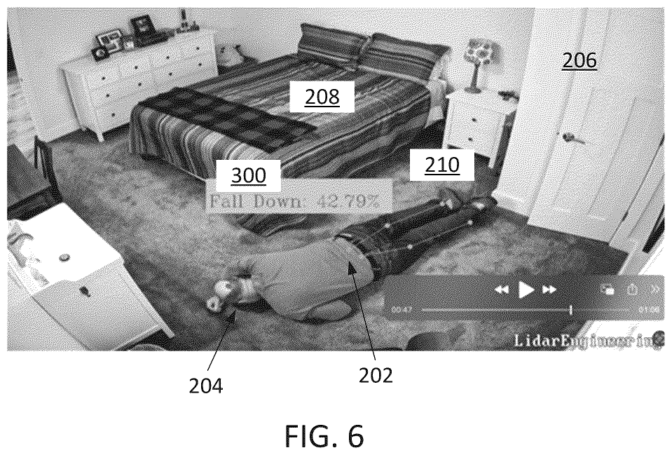

In contrast to FIG. 5, FIG. 6 illustrates the system identifying a subject as falling. FIG. 6 shows a similar angular skeletal pose as FIG. 5, but the subject is not “on bed.” The system 100 correctly classifies the subject 204 as “fall down,” because the system 100 determines the subject 204 is on the floor 210 or, alternatively, not on the bed. Additionally, the system 100 may identify the transition of the subject from either the “on bed” pose to the “fall down” pose or from the “walking” pose of FIG. 4 to the “fall down” pose of FIG. 6.

For training the pose estimator 110 with a training set, if the pose estimator 110 is unable to classify pose 400 in a frame correctly, the administrator may add missing key points 202 or correct their placement so that the pose estimator 110 may learn. For example, if the pose estimator 110 can only identify 8 key points 202, the user may add additional key points 202 until the system 100 can classify the pose 400 correctly.

Similarly for the pose classified 112, the administrator may correct the pose classification model if the system 100 mislabels a pose.

Training of the pose estimator 110 may be performed through administrative access by an administrator using one of the client devices 120. In training mode, an administrator may identify key points 202 of images that the pose estimator 110 was unable to identify.

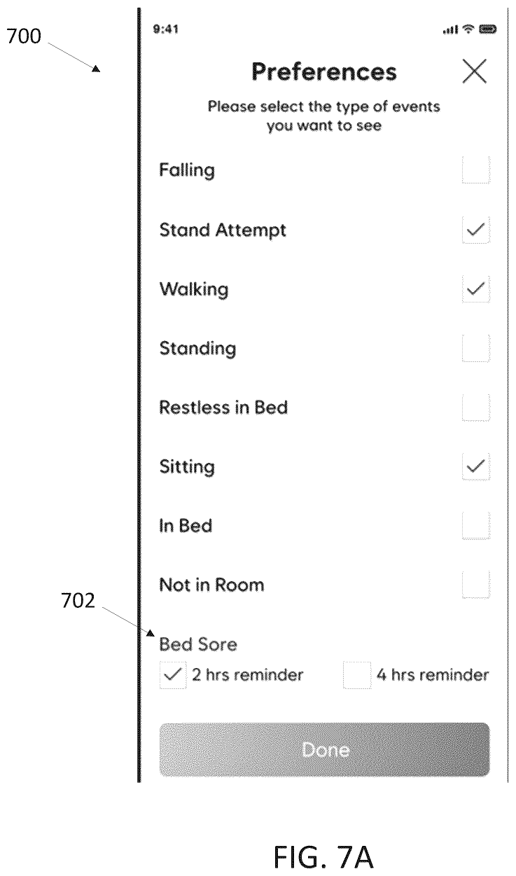

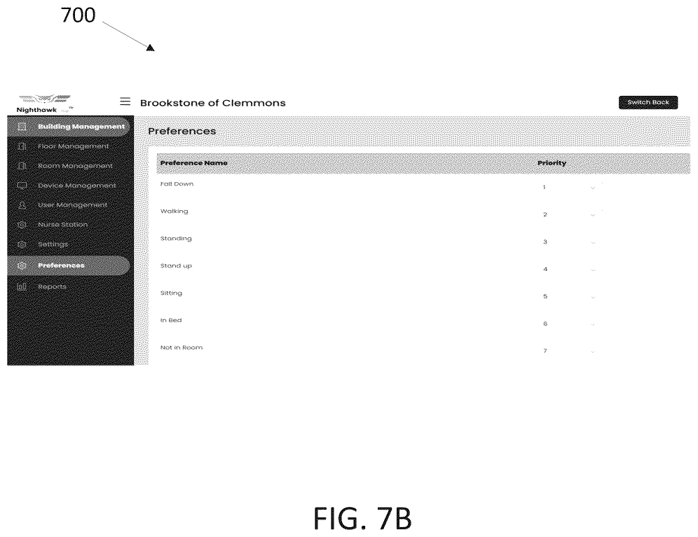

FIG. 7A illustrates preferences monitored by the system 100 on an application 700, corresponding to events the system 100 detects. The application 700 may run on the client devices 120 such as a phone in FIG. 7A or may be a web application, smart watch, or the like. The events listed in the application 700 and monitored by the system 100 may include the events or poses 400 included in FIG. 7A. For example, the selectable events or poses 400 may include falling, stand attempt, walking, standing, restless in bed, sitting, in bed, not in room, and bed sore. The application 700 allows a user to select events or poses 400 that trigger an alarm or notification when detected by the system 100. In this example, push notifications or alarms go to the user's phone. There may be multiple preferences for each event. For example, the “bed sore” option 702 includes a selectable alarm for repositioning. For example, a 2 or 4-hour alarm for repositioning. This is important as many fall risk patients are also prone to bed sores or pneumonia which requires repositioning of the subject's pose.

The system 100 also utilizes ID Guard to conceal the client's identity for privacy issues. Furthermore, by using one or more standard cameras (e.g., monocular), the system may include of one or more discreet cameras to overcome subjects' anxieties of seeing larger, complex depth camera looking at them.

Alarms triggered in by the application 700 are sent through push notifications or similar type of alarm on the client devices 120 indicating that a selected event has occurred. In some examples, such as the repositioning alert, an alarm may also be sent to the subject in the room and continue to ring until the subject repositions. For example, there may be a speaker in the room or other client device 120, such as a smart watch, to notify a subject to reposition.

With some poses 400 being angular close to one another, such as a stand attempt versus standing, there may be preferences set to determine the most important pose. To compensate for this, the system 100 includes an algorithm that prioritizes the severity of the incident and holds that event for a time period to avoid nuisance messages. For example, a fall condition is the highest alert status with stand attempt as second highest alert status. The fall alert would be sent to the caretaker's phone application 700, and they caretaker can select take action, live view of the room, or send to another caretaker if they are busy.

The system's 100 processing circuitry 114 prioritizes the severity of the incident and holds the event for a time period to avoid nuisance messages and may include the user ranking the priority of poses 400, as shown in FIG. 7B. The user may use the application 700 to select the priority of poses shown in FIG. 7B. The user may be able to set different preferences for different rooms or buildings.

In embodiments, the owner operator of the system 100 can select how long they would like to pay for recorded events. This is beneficial for monitoring such as walks for rehab facilities for insurance purposes. This is also beneficial for liability concerns to show when a fall happened and when service was provided.

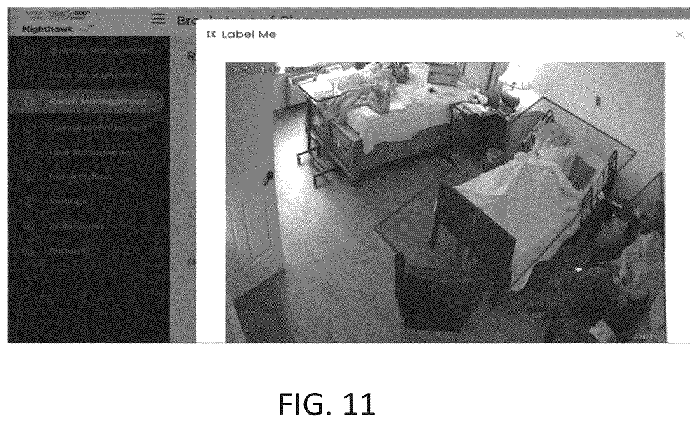

In embodiments, the FoV of the camera 102 can be subdivided into several virtual areas of interest to help differentiate which poses are of interest within a given area (see, e.g., FIG. 11). Specifically, if the subject is horizontal on the area: floor (falling down), versus horizontal on the area: bed (lying down). Reporting of alarms can combine the subject's location area with their pose 400, or simply be a function of their pose 400. Additionally, alarms can be reported if a subject transitions from one area to another. In another embodiment an alarm is activated when the subject 204 spends a length of time within an area or outside of an area. An example could be that the subject passes into a doorway to another room (bathroom) and does not return within a specified time frame. A timer may be used by the processing circuitry 114 when triggered by certain events, such as the object detector 108 detecting or not detecting a subject in the room or detecting a second subject in the room. Certain alerts may be sent to a user based on the timers reaching a predetermined threshold. For example, a user may set a timer for subject to be in the bathroom, if the user is out of frame beyond the threshold, an alarm may be triggered.

In another example, the system 100 processing circuitry 114 keeps track of the length of time it takes for another subject to enter the FoV after an adverse event. The system 100 saves the length of time between the start of the adverse event and when the second subject enters the FoV to the storage 118. The system 100 may also save the video feed of the identified time. In an embodiment, reporting of alarms may be suspended if more than one subject is within the FoV. The assumption is that the second subject is a caregiver or visitor that can respond to or report an adverse event. This simple and unique approach saves computational bandwidth of the system 100.

In an embodiment, the camera 102 may continue to record when an adverse event occurs, such when a pose 400 like falling down or bed sores until a second subject enters the room. The system 100 may begin a timer after the adverse event (e.g., a pose 400 of falling down) and stop the timer when another subject enters the FoV. In this way, the time between an adverse event and the response by the monitoring party may be captured. The timestamp for when a pose 400 occurs and when a second subject enters the room may be saved to a server. In embodiment, each change in pose 400 is saved to a server with a timestamp.

A timer may not be limited to adverse events but is started after each event detected. For example, a bed sore alarm 702 is determined by the subject 204 staying in the laying down pose 400 and not repositioning for an extended period of time. A reposition status may be determined by the system 100 if there is a change in the subject's 204 pose 400 or the subject 204 remains in the laying down pose 400 but moves sufficiently to be categorized a repositioned. Each change in pose 400, including repositioning, may be logged in the application 700 and may be saved to a server. The predetermined time to be repositioned may be set by a user in the application 700. If the laying down and repositioned status has not changed for a predetermined period of time, then an alarm may be triggered on the application 700.

In an embodiment, the camera 102 recordings are saved when certain poses are detected. In an embodiment, when a subject's 204 pose 400 changes, the camera 102 may record the subject for a predetermined amount time. For example, the predetermined amount of time of recording may be one (1) minute. The camera recording may be saved to the storage 118 on the server 104. In another embodiment, when a pose is detected the user may allow a live stream of the room to be broadcasted to a client device 120.

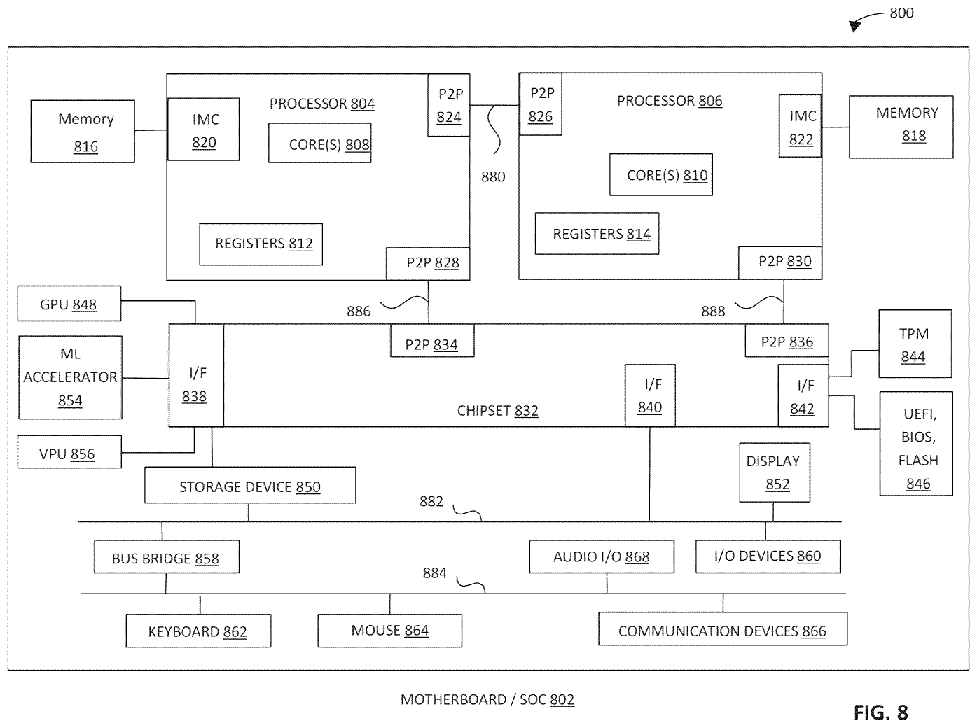

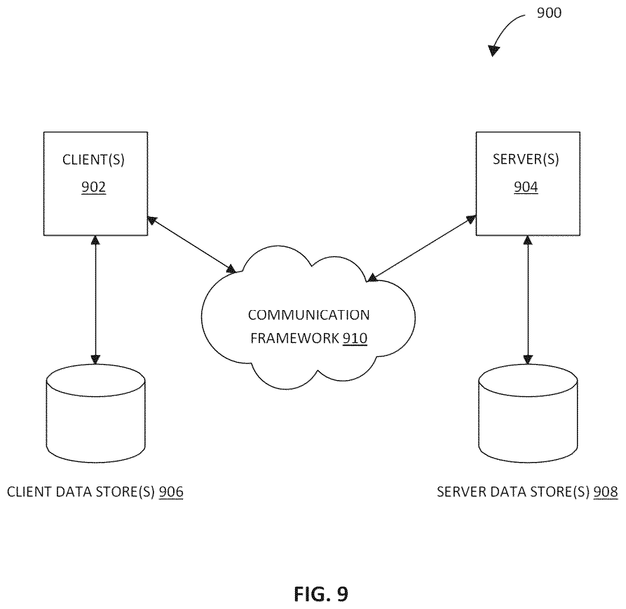

FIG. 8 and FIG. 9 illustrate an embodiment of a system 800 and communications architecture 900 respectively that may be suitable for implementing various embodiments described hereby.

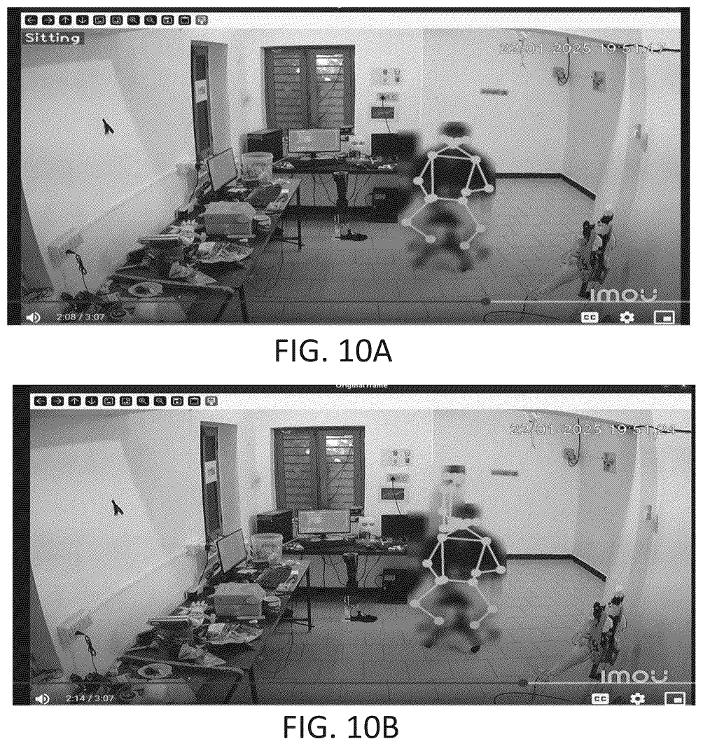

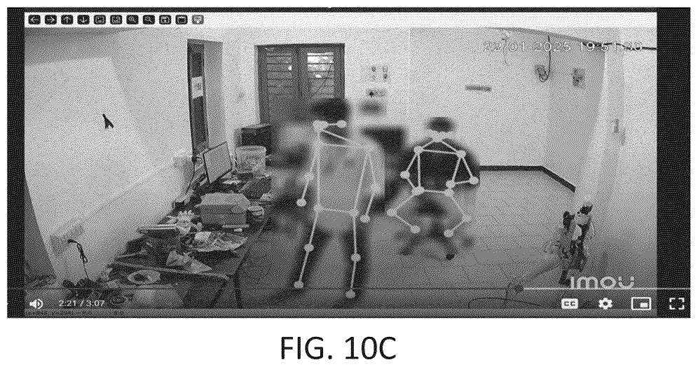

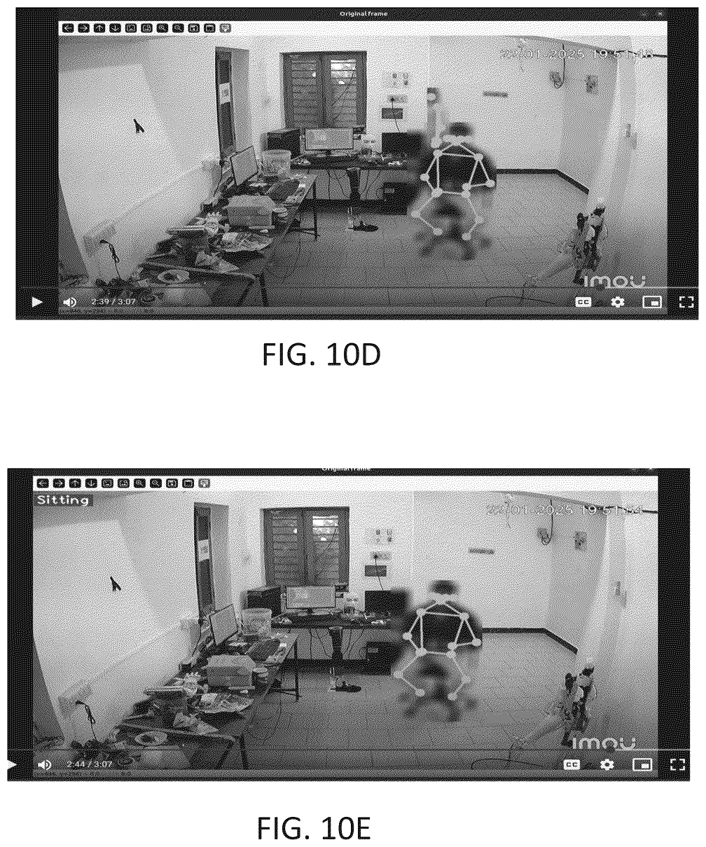

FIG. 10A-E illustrates the system 100 detecting the pose 400 of the subject 204 as described previously. The system 100 detects a subject's pose 400 of sitting in FIG. 10A. The pose may be recorded with a time stamp. In FIG. 10B-10D, the system 100 detects two subjects in the frame and stops classifying the subject's pose 400. A timestamp may be recorded when a second subject enters the FoV. When the second subject leaves the FoV, the subject's pose 400 is identified as sitting. Alternatively, the system may still classify the subject's pose in FIGS. 10A-10E but pause notifications in the application 700.

FIG. 11 shows another example of the application 700 with a labeling feature. For each room in a facility that the system 100 is deployed, the user may select which portions of the room are a bed, chair, or other furniture object that effect's a subject's pose 400. The system 100 saves the labeled rooms for identifying a subject's pose 400 accurately. The system 100 may categorize a building with floors and rooms to be managed in the application 700.

FIG. 8 illustrates an embodiment of a system 800 that may be suitable for implementing various embodiments described hereby. System 800 is a computing system with multiple processor cores such as a distributed computing system, supercomputer, high-performance computing system, computing cluster, mainframe computer, mini-computer, client-server system, subjectal computer (PC), workstation, server, portable computer, laptop computer, tablet computer, handheld device such as a subjectal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, and the like. Further embodiments implement larger scale server configurations. In other embodiments, the system 800 may have a single processor with one core or more than one processor. Note that the term “processor” refers to a processor with a single core or a processor package with multiple processor cores. In at least one embodiment, the computing system 800, or one or more components thereof, is representative of one or more components described hereby, such as the system 100 on the server 104. More generally, the computing system 800 may be configured to implement embodiments including logic, systems, logic flows, methods, apparatuses, and functionality described hereby. The embodiments, however, are not limited to implementation by the system 800.

As used in this application, the terms “system” and “component” and “module” are generally intended to refer to a computer-related entity, either hardware, a combination of hardware and software, software, or software in execution, examples of which are provided by the exemplary system 800. For example, a component can be, but is not limited to being, a process running on a processor, a processor, a hard disk drive, multiple storage drives (of optical, solid-state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

Although not necessarily illustrated, the computing system 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. Further, the computing system 800 may include or implement various articles of manufacture. An article of manufacture may include a non-transitory computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, encrypted code, and the like, implemented using any suitable high-level, low-level, object-oriented, visual, compiled, and/or interpreted programming language. Embodiments may also be at least partly implemented as instructions contained in or on a non-transitory computer-readable medium, which may be read and executed by one or more processors to enable performance of the operations described herein.

As illustrated in FIG. 8, the system 800 comprises a motherboard or system-on-chip (SoC) 802 for mounting platform components. Motherboard or system-on-chip (SoC) 802 is a point-to-point (P2P) interconnect platform that includes a first processor 804 and a second processor 806 coupled via a point-to-point interconnect 870 such as an Ultra Path Interconnect (UPI). In other embodiments, the system 800 may be of another bus architecture, such as a multi-drop bus. Furthermore, each of processor 804 and processor 806 may be processor packages with multiple processor cores including core(s) 808 and core(s) 810, respectively. While the system 800 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processor 804 and chipset 832. Some platforms may include additional components and some platforms may only include sockets to mount the processors and/or the chipset. Furthermore, some platforms may not have sockets (e.g., SoC, or the like).

The processor 804 and processor 806 can be any of various commercially available processors. Dual microprocessors, multi-core processors, and other multi-processor architectures may also be employed as the processor 804 and/or processor 806. Additionally, the processor 804 need not be identical to processor 806.

Processor 804 includes an integrated memory controller (IMC) 820 and point-to-point (P2P) interface 824 and P2P interface 828. Similarly, the processor 806 includes an IMC 822 as well as P2P interface 826 and P2P interface 830. IMC 820 and IMC 822 couple the processors processor 804 and processor 806, respectively, to respective memories (e.g., memory 816 and memory 818). Memories 816, 818 can store instructions executable by circuitry of system 800 (e.g., processor 804, processor 806, graphics processing unit (GPU) 848, ML accelerator 854, vision processing unit (VPU) 856, or the like). For example, memories 816, 818 can store instructions for one or more of application 700, the system 100 and data manipulations and communications described hereby, operations of the system 100, predictive models or analytics, and the like. In another example, memories 816, 818 can store data, such images, models, algorithms, settings, alarms preferences, poses 400, and labeled images and the like. Memory 816 and memory 818 may be portions of the main memory (e.g., a dynamic random-access memory (DRAM)) for the platform such as double data rate type 3 (DDR3) or type 4 (DDR4) synchronous DRAM (SDRAM). In the present embodiment, the memory 816 and memory 818 locally attach to the respective processors (i.e., processor 804 and processor 806). In other embodiments, the main memory may couple with the processors via a bus and/or shared memory hub.

System 800 includes chipset 832 coupled to processor 804 and processor 806. Furthermore, chipset 832 can be coupled to storage device 850, for example, via an interface (I/F) 838. The I/F 838 may be, for example, a Peripheral Component Interconnect-enhanced (PCI-e). In many embodiments, storage device 850 comprises a non-transitory computer-readable medium. Storage device 850 can store instructions executable by circuitry of system 800 (e.g., processor 804, processor 806, GPU 848, ML accelerator 854, vision processing unit 856, or the like). For example, storage device 850 can store instructions for one or more of operations of the system 100 and operations of the server 104, and operations of the predictive models, or analytics, and the like. In another example, storage device 850 can store data, such as instructions for one or more of application 700 and the system 100 data manipulations and communications described hereby, operations of the system 100, operations of the server 104, and operations of the predictive models or analytics, and the like. In some embodiments, instructions may be copied or moved from storage device 850 to memory 816 and/or memory 818 for execution, such as by processor 804 and/or processor 806.

Processor 804 couples to a chipset 832 via P2P interface 828 and P2P interface 834 while processor 806 couples to a chipset 832 via P2P interface 830 and P2P interface 836. Direct media interface (DMI) 876 and DMI 878 may couple the P2P interface 828 and the P2P interface 834 and the P2P interface 830 and P2P interface 836, respectively. DMI 876 and DMI 878 may be a high-speed interconnect that facilitates, e.g., eight Giga Transfers per second (GT/s) such as DMI 3.0. In other embodiments, the components may interconnect via a bus.

The chipset 832 may comprise a controller hub such as a platform controller hub (PCH). The chipset 832 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 832 may comprise more than one controller hub such as a chipset with a memory controller hub, a graphics controller hub, and an input/output (I/O) controller hub.

In the depicted example, chipset 832 couples with a trusted platform module (TPM) 844 and UEFI, BIOS, FLASH circuitry 846 via I/F 842. The TPM 844 is a dedicated microcontroller designed to secure hardware by integrating cryptographic keys into devices. The UEFI, BIOS, FLASH circuitry 846 may provide pre-boot code.

Furthermore, chipset 832 includes the I/F 838 to couple chipset 832 with a high-performance graphics engine, such as, graphics processing circuitry or a graphics processing unit (GPU) 848. In other embodiments, the system 800 may include a flexible display interface (FDI) (not shown) between the processor 804 and/or the processor 806 and the chipset 832. The FDI interconnects a graphics processor core in one or more of processor 804 and/or processor 806 with the chipset 832.

Additionally, ML accelerator 854 and/or vision processing unit 856 can be coupled to chipset 832 via I/F 838. ML accelerator 854 can be circuitry arranged to execute ML related operations (e.g., training, inference, etc.) for ML models. Likewise, vision processing unit 856 can be circuitry arranged to execute vision processing specific or related operations. In particular, ML accelerator 854 and/or vision processing unit 856 can be arranged to execute mathematical operations and/or operands useful for machine learning, neural network processing, artificial intelligence, vision processing, etc.

Various I/O devices 860 and display 852 couple to the bus 872, along with a bus bridge 858 which couples the bus 872 to a second bus 874 and an I/F 840 that connects the bus 872 with the chipset 832. In one embodiment, the second bus 874 may be a low pin count (LPC) bus. Various I/O devices may couple to the second bus 874 including, for example, a keyboard 862, a mouse 864, and communication devices 866.

Furthermore, an audio I/O 868 may couple to second bus 874. Many of the I/O devices 860 and communication devices 866 may reside on the motherboard or system-on-chip (SoC) 802 while the keyboard 862 and the mouse 864 may be add-on peripherals. In other embodiments, some or all the I/O devices 860 and communication devices 866 are add-on peripherals and do not reside on the motherboard or system-on-chip (SoC) 802. More generally, the I/O devices of system 800 may include one or more of microphones, speakers, infra-red (IR) remote controls, radio-frequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, track pads, sensors, styluses, displays, augmented/virtual reality devices, printers, actuators, motors, transducers, and the like.

FIG. 8 is a block diagram depicting an exemplary communications architecture 800 suitable for implementing various embodiments as previously described, such as communications between a camera the system 100, between the system 100 and the application 700, between the system 100 and the server, and/or between the server and the database. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 9, the communications architecture 900 includes one or more client(s) 902 and server(s) 904. In some embodiments, each client 902 and/or server(s) 904 may include a computing system (e.g., system 800) The server(s) 904 may implement one or more devices of system 100. The client(s) 902 and the server(s) 904 are operatively connected to one or more respective client data store(s) 906 and server data store(s) 908 that can be employed to store information local to the respective client(s) 902 and server(s) 904, such as cookies and/or associated contextual information. In various embodiments, any one of server(s) 904 may implement one or more logic flows or operations described hereby, such as in conjunction with storage of data received from any one of client(s) 902 on any of server data store(s) 908. In one or more embodiments, one or more of client data store(s) 906 or server data store(s) 908 may include memory accessible to one or more portions of components, applications, and/or techniques described hereby.

The client(s) 902 and the server(s) 904 may communicate information between each other using a communication framework 910. The communication framework 910 may implement any well-known communications techniques and protocols. The communication framework 910 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 910 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount of speed and capacity, distributed network controller architectures may similarly be employed to pool, load balance, and otherwise increase the communicative bandwidth required by client(s) 902 and the server(s) 904. A communications network may be any one and the combination of wired and/or wireless networks including without limitation a direct interconnection, a secured custom connection, a private network (e.g., an enterprise intranet), a public network (e.g., the Internet), a Subjectal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. For example, the circuitry of the system 100 may utilize at least one ASIC while the server may utilize at least one microprocessor.

The various devices, components, modules, features, and functionalities described hereby may include, or be implemented via, various hardware elements, software elements, or a combination of both. Examples of hardware elements may include devices, logic devices, hardware components, processors, microprocessors, circuits, circuitry, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, algorithms, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds, and other design or performance constraints, as desired for a given implementation. It is noted that hardware, firmware, and/or software elements may be collectively or individually referred to herein as “logic,” “circuit,” or “circuitry.”

One or more aspects of at least one embodiment may be implemented by representative instructions stored on a machine-readable medium which represents various logic within the processor, which when read by a machine causes the machine to fabricate logic to perform the techniques described hereby. Such representations, known as “IP cores,” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, and the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, and the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, and the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose, or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

The components of the apparatus illustrated are not limited to the specific embodiments described herein, but rather, features illustrated or described as part of one embodiment can be used on or in conjunction with other embodiments to yield yet a further embodiment. It is intended that the apparatus include such modifications and variations. Further, steps described in the method may be utilized independently and separately from other steps described herein.

While the apparatus and method have been described with reference to specific embodiments, it will be understood by those skilled in the art that various changes may be made, and equivalents may be substituted for elements thereof without departing from the scope contemplated. In addition, many modifications may be made to adapt a particular situation or material to the teachings found herein without departing from the essential scope thereof.

In this specification and the claims that follow, reference will be made to a number of terms that have the following meanings. The singular forms “a,” “an” and “the” include plural referents unless the context clearly dictates otherwise. Furthermore, references to “one embodiment,” “some embodiments,” “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

Advances in science and technology may make equivalents and substitutions possible that are not now contemplated by reason of the imprecision of language; these variations should be covered by the appended claims. This written description uses examples to disclose the method, machine and computer-readable medium, including the best mode, and also to enable any subject of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method comprising:
identifying, by a processing circuitry, a subject in a room on a camera feed received from a monocular camera via a network with an object detection model;
mapping, by the processing circuitry, key points of the subject in the camera feed with a pose estimation model;
classifying, by the processing circuitry, a pose of the subject based on the key points; and
sending an alert over the network based on the classified pose to a client device.

2. The method of claim 1, wherein the key points are skeletal reference points of the subject.

3. The method of claim 1 further comprising:
processing the camera feed on a server into a 2-D image comprising:
extracting each frame in the camera feed; and
resizing and normalizing each frame.

4. The method of claim 1 further comprises:
obscuring an identity of the subject.

5. The method of claim 1 further comprises:
identifying a second subject in the camera feed.

6. The method of claim 5, wherein identifying the second subject in the camera feed further comprises:
saving a recording of the camera feed to a storage device; and
stopping the recording of the camera feed.

7. The method of claim 1, wherein classifying the pose of the subject based on the key points, further comprises:
determining a coordinate for each key point;
determining an angle and distance between each coordinate; and
determining the pose of the subject based on a rules-based classification using the angle and distance measurements.

8. The method of claim 7, wherein classifying the pose of the subject based on the key points, further comprises:
determining a confidence percentage based a confidence level of each of the coordinates, wherein the confidence percentage is a weighted average of all the confidence levels and the confidence level is a value between 1 and 0.

9. The method of claim 1 further comprises:
determining a length of time the subject is in the classified pose;
determining the length of time is beyond a threshold; and
sending a repositioning alert to the client device.

10. The method of claim 9, wherein the length of time is reset when the subject has a new classified pose.

11. The method of claim 9, wherein the repositioning alert is an alarm through a speaker in the room.

12. The method of claim 1, wherein the pose comprises at least one of standing, walking, sitting, falling down, or lying down.

13. A system comprising:
at least one processing unit; and
at least one memory coupled to the at least one processing unit and storing instructions for execution by the at least one processing unit, wherein the instructions, when executed by the at least one processing unit, cause the system to perform actions comprising:
identifying, by a processing circuitry, a subject in a room on a camera feed received from a monocular camera via a network with an objection detection model;
mapping, by the processing circuitry, key points of the subject in the camera feed with a pose estimation model;
classifying, by the processing circuitry, a pose of the subject based on the key points; and
sending an alert over the network based on the classified pose to a client device.

14. The system of claim 13, wherein the key points are skeletal reference points of the subject.

15. The system of claim 13 further comprising:
processing the camera feed on a server into a 2-D image comprising:
extracting each frame in the camera feed; and
resizing and normalizing each frame.

16. The system of claim 13, wherein the instructions, when executed by the at least one processing unit, cause the system to perform actions further comprising:
obscuring an identity of the subject.

17. The system of claim 13, wherein the instructions, when executed by the at least one processing unit, cause the system to perform actions further comprising:
identifying a second subject in the camera feed.

18. The system of claim 17, wherein identifying the second subject in the camera feed further comprises:
saving a recording of the camera feed to a storage device; and
stopping the recording of the camera feed.

19. The system of claim 13 further comprises:
determining a length of time the subject is in the classified pose;
determining the length of time is beyond a threshold; and
sending a repositioning alert to the client device.

20. The system of claim 19, wherein the length of time is reset when the subject has a new classified pose.
